(19) United States
(12) Patent Application Publication
(10) Pub. No.: US 2015/0203081 A1
(43) Pub. Date: Jul. 23, 2015

(54) BRAKING SYSTEMS

(71) Applicant: SENTINEL SYSTEMS LIMITED, Gloucestershire (GB)

(72) Inventor: William Paulson, Gloucestershire (GB)

(21) Appl. No.: 14/417,129

(22) PCT Filed: Jul. 24, 2013
(86) PCT No.: PCT/GB2013/051984

§ 371 Date: Jan. 23, 2015

(30) Foreign Application Priority Data
Jul. 24, 2012 (GB) 1213171.0

(51) Int. Cl. B60T 7/22; B60T 8/58

(52) U.S. Cl. CPC B60T 7/22; B60T 8/58

(57) ABSTRACT

Apparatus for controlling braking of a vehicle 1 includes an object proximity detection system for detecting an object in the path of the vehicle and an electronic braking system responsive to detection of an object within a predetermined distance of the vehicle by the object proximity detection system to apply the brakes to stop the vehicle. The object proximity detection system comprises one or more programmable radar heads 2a, 2b operable to provide a signal to a control unit 4 of the electronic braking system when an object id detected in the path of the vehicle. The radar heads 2a, 2b may be provided at the rear and/or front of the vehicle. The radar heads 2a, 2b are adjustable to alter the direction and range of the detection area covered by the radar heads 2a, 2b. The electronic braking system applies the brakes for a pre-determined period of time when an object is detected after which the brakes are released and the system re-set.

This invention relates to vehicle braking systems and in particular to vehicles provided with an electronic braking system (EBS). More especially, the invention relates to an interface between the vehicle EBS and an object proximity detection system (OPDS) that enables the application of a service brake and/or a park brake on a vehicle in response to the detection of an object, such as a person, in the path of the vehicle. Typically the OPDS system may comprise one or more sensors mounted on the vehicle for detecting an object within a pre-determined distance of the vehicle. The invention has application to a wide range of vehicles including heavy plant vehicles, earth moving vehicles, cars, buses, vans, trucks and lorries and is particularly useful for automatically applying the service brake and/or park brake when reversing the vehicle in response to detection of an object in the path of the vehicle.

According to a first aspect of the invention, there is provided in or for a vehicle, apparatus including an electronic braking system for controlling braking, an object proximity detection system for detecting an object in the path of the vehicle, and means for interfacing between the object proximity detection system and the electronic braking system such that, in use, the electronic braking system is responsive to detection of an object within a pre-determined distance of the vehicle by the object proximity detection system to apply the brakes to stop the vehicle for a pre-determined period of time after which the brakes are released and the system re-set and wherein the object proximity detection system comprises one or more programmable radar heads.

According to a second aspect of the invention, there is provided a method of controlling braking of a vehicle fitted with an electronic braking system to avoid collision with objects in the path of the vehicle, the method including providing the vehicle with an object proximity detection system including at least one sensor for detecting an object in the path of the vehicle, and providing means for interfacing between the object proximity detection system and the electronic braking system such as to respond to detection of an object within a pre-determined distance of the vehicle and apply the brakes to stop the vehicle for a pre-determined period of time after which the brakes are released and the system re-set and wherein the object proximity detection system comprises one or more programmable radar heads.

It may be that the or each radar head comprises at least one radar sensor. A number of radar sensors may be linked together to form a radar detection area. In some embodiments a number of radar heads may be linked together and a single signal sent to the electronic braking system in the event that an object is detected by any one of the radar heads. Detection of an object by any one of the radar sensors causes a signal to be sent to the electronic braking system.

It may be that a plurality of radar sensors are provided at appropriate locations on the vehicle. The sensors may be built into the vehicle, for example in the bumpers at the front and/or rear of the vehicle. Alternatively, the sensors may be provided in a separate support member for mounting on the vehicle, for example a profile strip, carrying one or more sensors for detachable mounting at the front and/or rear of the vehicle.

The sensors may be configured to detect an object in an area that is not visible to the driver when manoeuvring the vehicle, for example objects that are hidden from the driver when reversing a vehicle. The sensors may be adjustable to alter the area/zone covered by each sensor. For example, each sensor may generate a signal covering a cone or fan-shaped area and be adjustable to change the height and/or direction of the area covered by the signal.

In some embodiments the or each radar head may be programmable to control a detection area in which an object is detected. Means may be provided for programming the or each radar sensor after installation to control the area/zone covered by each sensor. It may also be desirable that a range and a sensitivity of the or each respective radar head and/or sensor can be adjusted when the radar head and/or sensor is in use on a vehicle. The range may be set by an engineer and may be inputted by a data input means such as a computer. Parameters such as detection length, detection width and sensitivity can be adjusted by the data input means.

In previous systems it has been necessary to provide an interface between ultrasonic sensors and the electronic braking system in order to convert an analogue signal from the ultrasonic sensors to a controller area network (CAN) bus signal that could be sent to the electronic braking system. An advantage of the present invention is that the or each radar head can send a CAN bus signal directly to the electronic braking system without the need for an intermediate control system.

The service brake and/or park brake may be applied for a pre-determined time following detection of an object within a pre-determined distance of the vehicle after which the brake may be released and the system re-set if the object is no longer detected within the pre-determined distance of the vehicle. For example, if the system is triggered by the detection of a person within the pre-determined distance who then moves away from the vehicle before the system times out. However, it may be that the system does not re-set and the brakes remain applied if a detected object remains within the pre-determined distance when the system times out. In this way, the vehicle is prevented from moving until the presence of the object has been investigated and, where appropriate, removed. Alternatively or additionally, means may be provided to over-ride the automatic application of the brakes under the direction of the driver to enable the vehicle to be moved.

It may be that the electronic braking system is arranged to apply the brakes for a period of time on receipt of a CAN bus signal from one or more of the radar heads. In some embodiments the electronic braking system may be arranged to release the brakes after they have been applied for the predetermined period of time. In some embodiments the brakes may be applied for a predetermined period of time from 1 to 10 seconds or more preferably from 3 to 5 seconds.

It may be that means is provided for activating/de-activating the object proximity detection system. For example, the object proximity detection system may be de-activated for normal driving of the vehicle and activated when carrying out a manoeuvre requiring knowledge of objects in the path of the vehicle such as when reversing the vehicle and/or when parking the vehicle. In this way, inadvertent activation of the electronic braking system to apply the service brake and/or park brake of the vehicle that may cause an accident when the vehicle is being driven normally can be avoided. Such means may be manually operated allowing the object proximity detection system to be activated and de-activated by the driver when required. With this arrangement, the CAN bus may interface with means to provide the driver with a visual and/or audible warning that the system has been activated to reduce the risk of the system being left on inadvertently when driving the vehicle normally, for example a flashing light or buzzer.

Alternatively or additionally, the object proximity detection system may be configured so as to be operable at low speeds and automatically de-activated when the vehicle speed exceeds a pre-determined limit, for example 10 mph (miles per hour).

It may be that the object proximity detection system is deactivated at vehicle speeds above 10 mph. The system may be arranged such that a signal may be sent by from the radar sensors but the electronic braking system is arranged to reject such signals if the vehicle speed is greater than 10 mph. It may be that the electronic braking system is arranged to disregard a CAN bus signal from one or more of the radar heads if the vehicle speed exceeds a predetermined limit, for example 10 mph. If the vehicle is moving at a speed that is less than the predetermined limit, the brakes are applied and released as described above.

In some embodiments the electronic braking system may be manually deactivated at speeds below the predetermined speed.

The electronic braking system may be of any suitable type. For example, the electronic braking system may control application of a service brake and/or park brake of the vehicle via a CAN bus. Any other suitable bus system may be employed. In one arrangement, the object proximity detection system outputs a CAN bus signal for input to a control unit of the electronic braking system. Other means of interfacing between the electronic braking system and the object proximity detection system are envisaged including both wired and wireless interfaces.

In some embodiments the or each radar head is arranged to send a CAN bus signal directly to the electronic braking system. In other embodiments a plurality of radar heads may be linked such that a single CAN bus signal is sent to the electronic braking system. In some embodiments the object proximity detection system may be provided with a control unit, although this is not essential. It may be desirable to provide a control unit to which each of the detection signals are sent prior to a CAN bus signal being sent from the control unit to the electronic braking system. The object proximity detection system control unit may also record data relating to the area of the detection zone and the angle of detection together with information relating to any object detected and a speed of the vehicle at the time of detection.

Where the object proximity detection system is provided at the rear of the vehicle, it may be activated/de-activated automatically in response to selection/deselection of reverse gear. Where the object proximity detection system is provided at both the front and rear of the vehicle, it may be configured to activate/de-activate the sensors at the rear of the vehicle automatically in response to selection/deselection of reverse gear and to activate/deactivate the sensors at the front of the vehicle manually in response to means operable by the driver, for example a switch. Alternatively, means operable by the driver may be employed to select manually the sensors at the front and/or rear of the vehicle according to requirements of the manoeuvre being carried out. Where sensors are activated at both the front and rear of the vehicle, if a control unit is provided it may be configured to respond to the sensors at the front only for forward movement of the vehicle and to the sensors at the rear only for backward movement of the vehicle. Alternatively, both the front and rear sensors may be operable at the same time.

It may be that the electronic braking system is configured to control the service brake and/or park brake when signalled in response to detection of an object in the path of the vehicle by the object proximity detection system to apply the required level of braking pressure to stop the vehicle. For example, the electronic control unit of the braking system may be operable to calculate the necessary braking force in response to the speed, weight and direction of the vehicle.

The electronic braking system may be configured to apply the brakes for a predetermined period of time, for example 10 seconds, 5 seconds or 3 seconds and then to release the brakes. The brakes may not be released if the object is still in the proximity zone.

It may be that the electronic braking system is arranged to send signal to the driver by means of a conventional cable and display. Preferably a visual display and an audio signal is provided to the driver in a cab of the vehicle. The visual display and/or audio signal may be provided to the cab by means of an electronic braking system cable that is connected between a tractor unit and a trailer unit. In some embodiments the display may indicate the side of the vehicle on which the object is located and the distance of the object from the vehicle or the trailer unit.

The system may be configured to provide self-test and/or diagnostic facility for producing information on the status/health of the electronic braking system and/or the object proximity detection system. For example, the self-test and/or diagnostic facility may generate pass/fail codes/signals for any part of the system and may permit identification of a failed part to facilitate repair/maintenance of the system. The system may be configured to record self-test and/or diagnostic results for analysis to assist monitoring of the system and possible identification of a fault before it occurs or becomes serious enough to present a safety risk.

The object proximity detection system may also be configured to record information relating to operation of the system such as the date, time of day, the name of the driver and if the brakes were activated automatically in response to detection of an object in the path of the vehicle. The object proximity detection system may be provided with a memory means or a data storage facility may be provided as part of a control unit if such a unit is provided. Such information may be useful in investigating any incident that occurs.

In some embodiments the object proximity detection system may be adapted to record a name of a driver. For example the object proximity detection system may record the name of a driver from a swipe card or other suitable input. Information from the swipe card may be used to supplement information from the electronic braking system in case there is an accident.

Local or remote interrogation of the system including any stored data may be provided for any purpose. For example, local interrogation may be provided via a hand held device such as a laptop or palmtop computer or similar data-handling device via any suitable connection such as an infrared data port. Alternatively or additionally, remote interrogation may be provided via a wireless link such as a radio frequency or infrared link to a computer or similar data-handling device.

The control unit of the electronic braking system may be provided with an appropriate connection for a CAN bus signal line from the object proximity detection system whereby the object proximity detection system can be retrofitted to an existing vehicle having an electronic braking system. For example, the CAN bus signal line from the or each radar head of the object proximity detection system may be provided with a waterproof plug or the like for releasable connection to the control unit of the electronic braking system. Alternatively, the system may be built-into a new vehicle.

The object proximity detection system may be configured to switch off automatically after a pre-determined period of time or if a park brake has been applied provided that the brakes have been applied in a safe mode.

The object proximity detection system may be installed, either as new or retro-fitted, to commercial type vehicles such as vans, truck and lorries. The system may be particularly advantageous with articulated tractor/trailer units. Advantageously the object proximity detection system may be provide on a trailer unit and may be arranged to operate when the trailer is connected to a shunting unit. An alternative electrical supply means may be provided if there is no electrical connection from the shunting unit. A connection to a cab of the shunting unit is preferably provided. The connection may be a wireless connection or a conventional electronic braking system connection may be utilised.

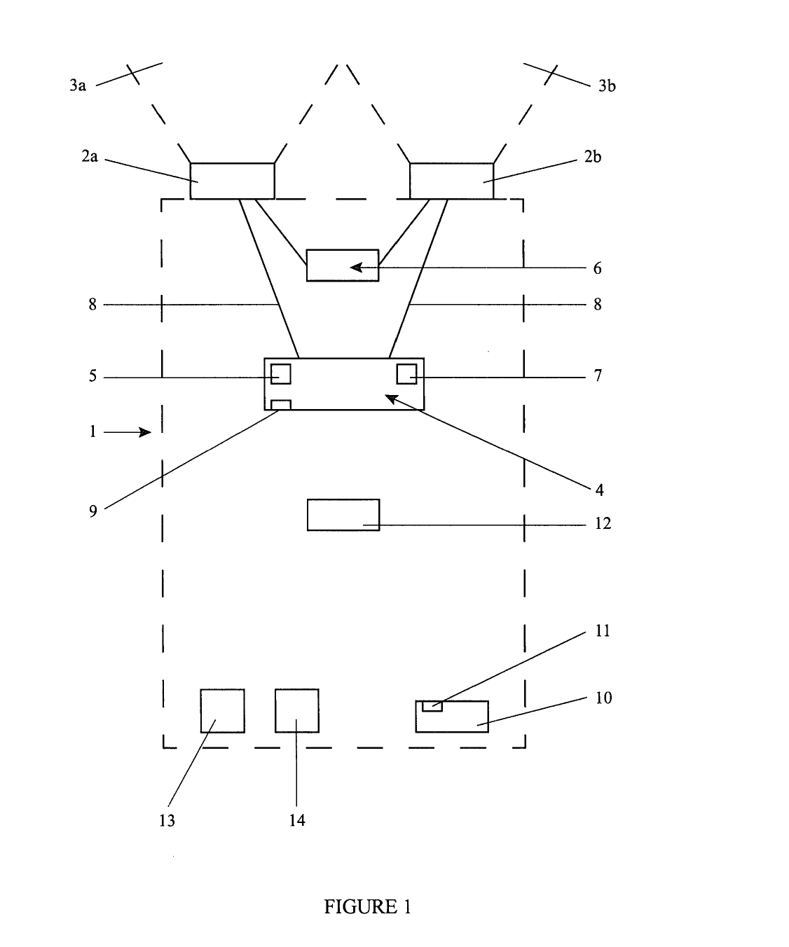

Embodiments of the invention will now be described in more detail, by way of example only, with reference to the accompanying drawing in which FIG. 1 schematically depicts the layout of an electronic braking system and object proximity detection system according to the invention.

Referring to the drawing, there is shown a schematic layout of a combined electronic braking system and object proximity detection system for a vehicle 1 in accordance with the present invention.

The object proximity detection system comprises a pair of radar heads 2a, 2b that are mounted on the rear of the vehicle 1 to detect an object in the path of the vehicle while reversing. The radar heads 2a, 2b may be built-in to the vehicle 1, for example the bumper or any other suitable location (while allowing removal for repair or replacement) or a detachable mounting may be provided for transferring the radar heads between vehicles. While two radar heads are shown, it will be understood that any number of radar heads from one or more may be employed according to requirements. The radar heads 2a, 2b each comprise a radar sensor.

In some embodiments, a radar head may comprise more than one radar sensor. The radar heads 2a, 2b are configured to cover a detection area 3a, 3b which, may be of cone shape or any other suitable shape. Detection areas may overlap.

The radar heads 2a, 2b are operatively connected to a control unit 4 of an electronic braking system. In this embodiment a 24 volt supply 6 may be provided by the vehicle battery or by a separate battery. The object proximity detection system is activated by connecting the battery power supply 6 to the radar heads 2a, 2b either automatically when reverse gear is selected or manually, for example by a switch or other means typically provided in the vicinity of the driver. Where the system is operated manually, the switch or other means may be configured to prevent or inhibit accidental “switch-ons” causing the system to be activated inadvertently.

When activated, the control unit 4 of the electronic braking system receives a signal from the sensors 2a, 2b when an object is detected within a pre-determined detection zone 3a, 3b. The radar sensors each transmit a signal and receive a reflected signal from an object in the path of the sensor 2a, 2b. If an object is detected in the detection zone 3a, 3b the or each radar sensor sends a signal to the control unit 4 of the electronic braking system. The radar sensors 2a, 2b may be linked so that one signal is sent from a number of sensors to the control unit 4 of the electronic braking system. The object proximity detection system may be arranged such that the first radar head to detect an object sends a signal to the control unit 4 of the electronic braking system and the electronic braking system initiates a response. The object proximity detection system may be arranged so that each radar head detecting an object sends a signal to the control unit 4 of the electronic braking system and the or each signal is sent from the electronic braking system to the cab to provide an audio or visual warning to the driver of the or each object detected. The radar heads 2a, 2b may be adjustable to alter the detection zone. For example, the range and/or direction of the detection zone may be altered.

The radar heads 2a, 2b may be set up to work individually or together and the electronic braking system programmed to respond accordingly. The object proximity detection system may be programmed to ignore objects nearer than a pre-determined minimum distance from the vehicle, for example, when reversing in a confined space signals from objects close the rear corners of the vehicle and not directly in the path of the vehicle may be ignored.

The object proximity detection system may include a memory means to input and store data relating to the systems settings and operation of the system, for example the date and time of each activation may be stored. The data relating to the systems settings and operation of the system may be stored in an audio/visual warning unit 10 in the cab of the vehicle. The audio/visual warning unit 10 may also store information relating to the driver using the vehicle. Stored data may be retrieved for analysis to check the operation of the system during routine maintenance/servicing and/or in the event of an accident. The object proximity detection system may be provided with a port 11 for connecting a device such as a laptop, palmtop or the like to input/retrieve data locally. Alternatively, data may be input/retrieved remotely by any suitable means.

In this embodiment, the control unit 4 is an electronic control unit that is connected to the vehicle service brakes 12 by a CAN bus system and the control unit 4 receives CAN bus signals from a pair of sensors 2a, 2b. For this purpose, the control unit 4 may be provided with at least one dedicated port for connecting the or each signal line 8 such that the object proximity detection system can be retrofitted to an existing vehicle fitted with the electronic braking system. Alternatively, the object proximity detection system and electronic braking system may be factory fitted as original equipment during manufacture of the vehicle.

If a single radar head is employed the signal may be sent directly from the radar head to the control unit 4 of the electronic braking system. When two or more radar heads are employed on the vehicle a CAN bus signal from each radar head is sent to the control unit and receipt of either of the CAN bus signals can initiate application of the brakes.

The control unit 4 of the electronic braking system has a programmable controller 5 such as a microprocessor and is operable in response to a CAN bus signal from the object proximity detection system to apply the service brakes 12 in a controlled manner. More specifically, the control unit 4 of the electronic braking system may be operable to determine the weight, speed and direction of the vehicle and to apply sufficient brake pressure, typically via an air-line, to stop the vehicle in a pre-determined distance to avoid contact with a detected object in the path of the vehicle. In this way, the braking force may be controlled to match the requirements for stopping the vehicle. The braking force may be higher when the vehicle is fully loaded than when it is partially loaded or empty. Also the braking force may be controlled to slow down and then stop the vehicle within a safe distance rather than apply the full braking force immediately to stop the vehicle. As a result, application of a braking force which may be significantly higher than is required and which can cause problems such as uncontrolled shifting of a vehicle load can be avoided.

The control unit 4 may be configured to apply the service brakes 12 for a pre-determined period of time after which the service brakes are released if the object proximity detection system does not detect an object in the path of the vehicle or if the park brake has been applied to prevent movement of the vehicle.

The object proximity detection system may be configured to switch off automatically after a pre-determined period of time, for example five minutes, or if the park brake has been applied to prevent movement of the vehicle.

The control unit 4 may include a memory 7 to input and store data relating to the operation of the braking system, for example the date and time of operation together with information such as the weight, speed and direction of the vehicle, the applied brake force, duration of the applied force and stopping distance may be stored. Stored data may be retrieved for analysis to check the operation of the system during routine maintenance/servicing and/or in the event of an accident. The control unit 4 may be provided with a port 9 for connecting a device such as a laptop, palmtop or the like to input/retrieve data locally. Alternatively, data may be input/retrieved remotely by any suitable means. The control unit 4 may also be configured to store information relating to the driver of the vehicle.

For example, the driver may be required to input personal identification details via a keypad, swipe card or other suitable means on start-up before the vehicle can be moved. In this way, the person in control of the vehicle at the time of an accident can be identified.

In use, when activated, the object proximity detection system may carry out an integrity self-test check on start-up and provide a warning if any fault is detected. For example the object proximity detection system may notify the electronic braking system if a fault is detected. The electronic braking system in turn provide the driver with a warning that there is a fault with the object proximity detection system, for example by providing a visual and/or audible warning 13 of the fault condition such as a flashing light and/or buzzer. Alternatively or additionally, the object proximity detection system may provide the warning to the driver. Under these conditions, the vehicle may still be driven and can be reversed but the driver may require assistance when reversing to warn of any objects in the path of the vehicle. The fault should be rectified as soon as possible and data relating to the cause of the fault may be stored in the memory of the object proximity detection system or the electronic braking system for downloading to assist any repair.

The object proximity detection system may be configured to provide an audible and/or visual warning 14 of the distance to an object in the path of the vehicle. Where provided, the audible warning may change according to the distance of the object from the vehicle. For example, the audible warning may comprise a continuous noise such as a buzzer or discontinuous noise such as beeps that increase in intensity (sound level) as the vehicle gets nearer to the object. The visual warning may comprise an array of lights that illuminate in sequence as the vehicle gets nearer to the object.

The electronic braking system may be configured to ignore any signal received from the object proximity detection system when the vehicle is travelling above a pre-determined speed or in a particular direction. For example, if the object proximity detection system is activated while the vehicle is travelling forward at or above the pre-determined speed, the vehicle brakes will not be activated if the object proximity detection system detects another vehicle approaching the rear of the vehicle within range of the sensors. The predetermined speed may be 10 mph.

Other features benefits and advantages of the invention will be apparent to those skilled in the art. For example, while the invention has particular application to an arrangement in which the object proximity detection system is provided with one or more radar heads at the rear of the vehicle to detect an object in the path of the vehicle while reversing, it will be appreciated that the object proximity detection system may be provided with one or more radar heads at the front of the vehicle. Where one or more radar heads is provided at the front of the vehicle, these may be similar the radar heads described above and may be arranged to provide a signal to the electronic braking system to apply the brakes if an object is detected in the path of the vehicle. One or more radar heads at the front of the vehicle may be provided in addition to one or more radar heads at the rear of the vehicle to assist when manoeuvring the vehicle. For example radar heads may be arranged to detect if the front corners of the vehicle approach an object whilst reversing. This can be a particular problem when reversing commercial vehicles such as buses, vans, trucks and lorries, especially articulated vehicles of the tractor/trailer type, where the driver is concentrating to avoid a collision at the rear of the vehicle and may not be aware of a potential impact at the front corners of the vehicle. Signals from the front radar heads may be used to provide an audible and/or visual warning of the distance of an object from the vehicle without applying the brakes. Alternatively or additionally, the signals from the front radar heads may be used to apply the brakes.

The invention has application to a wide range of vehicles and operating conditions. For example, where the object proximity detection system and electronic braking system are applied to the trailer of an articulated tractor/trailer unit, means may be provided to operate the systems when the trailer is coupled to a shunting unit to manoeuvre the trailer when disconnected from the tractor unit. For example, as there is generally no electric connection between the shunting unit and the trailer, a back-up battery may be provided to power the electronic braking system and object proximity detection system and a wireless link may be employed between the shunting unit and trailer to activate the back-up battery and/or provide the driver of the shunting unit with an audible or visual warning of the proximity of any objects while manoeuvring the trailer. The detection zone of the radar heads may be adjusted by means of controls. In some embodiments the zone may be adjusted by means of a computer or data handling device arranged to interrogate and adjust the object proximity detection system. In some embodiments the controls may be provided in the trailer.

It will be appreciated that the invention is not limited to the embodiment above-described and that any of the features described herein may be employed separately or in combination with any other features.

1. An apparatus, comprising:
an electronic braking system for controlling braking of a vehicle,
an object proximity detection system for detecting an object in the path of the vehicle, and
an interface between the object proximity detection system and the electronic braking system such that, in use, the electronic braking system is responsive to detection of an object within a pre-determined distance of the vehicle by the object proximity detection system to apply the brakes to stop the vehicle for a pre-determined period of time after which the brakes are released and the system re-set and wherein the object proximity detection system comprises one or more programmable radar heads.

2. (canceled)

3. (canceled)

4. (canceled)

5. (canceled)

6. (canceled)

7. The apparatus according to claim 1 wherein a plurality of radar heads are provided at the front and/or rear of the vehicle.

8. The apparatus according to claim 7 wherein the plurality of radar heads are provided in a separate support member for detachable mounting on the vehicle at the front and/or rear of the vehicle.

9. (canceled)

10. (canceled)

11. The apparatus according to claim 7 wherein the radar heads are adjustable to alter the height and/or direction of area/zone covered by each radar head.

12. (canceled)

13. (canceled)

14. The apparatus according to claim 1 wherein the or each radar head is programmable to control a detection area in which an object is detected.

15. The apparatus according to claim 14 wherein means is provided for programming the or each radar head after installation to control the area/zone covered by each radar head.

16. The apparatus according to claim 15 wherein a range and a sensitivity of the or each respective radar head can be adjusted when the radar head is in use on a vehicle.

17. The apparatus according to claim 15 wherein a data input is provided for adjusting one or more of detection length, detection width and sensitivity can be adjusted by the data input.

18. (canceled)

19. The apparatus according to claim 1 wherein a service brake and/or park brake is applied for a pre-determined time following detection of an object within a pre-determined distance of the vehicle after which the brake is released and the system re-set if the object is no longer detected within the pre-determined distance of the vehicle.

20. (canceled)

21. (canceled)

22. (canceled)

23. (canceled)

24. (canceled)

25. The apparatus according to claim 1 wherein the object proximity detection system can be de-activated for normal driving of the vehicle and activated when carrying out a manoeuvre requiring knowledge of objects in the path of the vehicle such as when reversing the vehicle and/or when parking the vehicle.

26. (canceled)

27. (canceled)

28. The apparatus according to claim 1 wherein the object proximity detection system is configured to be operable at low speeds and automatically de-activated when the vehicle speed exceeds a pre-determined limit.

29. (canceled)

30. (canceled)

31. The apparatus according to claim 1 wherein the object proximity detection system outputs a CAN bus signal for input to a control unit of the electronic braking system.

32. (canceled)

33. (canceled)

34. The apparatus according to claim 31 wherein a plurality of radar heads are linked such that a single CAN bus signal is sent to the electronic braking system.

35. (canceled)

36. The apparatus according to claim 1 wherein the object proximity detection system control unit records data relating to the area of the detection zone and the angle of detection together with information relating to any object detected and a speed of the vehicle at the time of detection.

37. (canceled)

38. The apparatus according to claim 1 wherein the object proximity detection system is provided at both the front and rear of the vehicle and is configured to activate/de-activate one or more radar heads at the rear of the vehicle automatically in response to selection/deselection of reverse gear and to activate/deactivate one or more radar heads at the front of 1 the vehicle manually in response to a selection/deselection mechanism operable by the driver.

39. The apparatus according to claim 1 wherein a selection mechanism operable by the driver is employed to select manually one or more radar heads at the front and/or rear of the vehicle according to requirements of the manoeuvre being carried out.

40. (canceled)

41. The apparatus according to claim 1 wherein the electronic braking system is configured to control braking when signalled in response to detection of an object in the path of the vehicle by the object proximity detection system to apply the required level of braking pressure to stop the vehicle.

42. (canceled)

43. (canceled)

44. (canceled)

45. (canceled)

46. (canceled)

47. (canceled)

48. The apparatus according to claim 1 wherein the system is configured to provide self-test and/or diagnostic facility for producing information on the status/health of the electronic braking system and/or the object proximity detection system.

49. (canceled)

50. The apparatus according to claim 48 wherein the self-test and/or diagnostic facility permits identification of a failed part to facilitate repair/maintenance of the system.

51. (canceled)

52. (canceled)

53. (canceled)

54. (canceled)

55. (canceled)

56. (canceled)

57. (canceled)

58. (canceled)

59. (canceled)

60. The apparatus according to claim 1 wherein the object proximity detection system is configured to switch off automatically after a pre-determined period of time or if a park brake has been applied provided that the brakes have been applied in a safe mode.

61. (canceled)

62. (canceled)

63. (canceled)
